(19) United States
(12) Patent Application Publication
(10) Pub. No.: US 2008/0193678 A1
(43) Pub. Date: Aug. 14, 2008

(54) Attaching Method of Nano Materials Using Langmuir-Blodgett

(75) Inventors: Chang-Soo Han, Daejeon (KR); Jae-Ho Kim, Gyeonggi-do (KR)

Correspondence Address: LEXYOUME IP GROUP, LLC, 1233 TWENTIETH STREET, N.W., SUITE 701, WASHINGTON, DC, 20036, US

(73) Assignee: KOREA INSTITUTE OF MACHINERY & MATERIALS, Daejeon-City (KR)

(21) Appl. No.: 11/994,106

(22) PCT Filed: Jul. 15, 2005
(86) PCT No.: PCT/KR05/02276

§ 371 Date: Dec. 27, 2007

(51) Int. Cl. B01J 19/08; B05D 1/00

(52) U.S. Cl. 427/598; 427/180; 427/457

(57) ABSTRACT

The present invention relates to a method for attaching nanomaterials by using a Langmuir-Blodgett method, wherein a Langmuir-Blodgett (LB) film, which is comprised of nanomaterials, is formed from a dispersed solution where the nanomaterials are stably dispersed in a volatile organic solvent, and then the nanomaterials of the LB film are transferred to a substrate or a holder. The method according to the present invention may be desirably applied to fabrication of a nanopattern structure, or manufacture of a probe, as a mechanical and electric device, for detecting signals such as surface or chemical signals.

### TECHNICAL FIELD

The present invention relates to a method for attaching nanomaterials to a substrate or a holder, specifically to a method for attaching nanomaterials for the fabrication of a nanopattern structure, or the manufacture of a signal probe having nanomaterials attached thereto by using an LB film.

### BACKGROUND ART

A nanopattern structure is a structure which has patterns in minimized scale as small as several hundreds of nanometers or less and is possible to be utilized as a new material having novel physical properties or as a sensor or active element responding to the outer environment correspondingly.

Nanomaterials useful in such nanopattern structure include nanomolecules in the form of particles such as gold (Au), aluminum (Al) and the like, nano structures in the shape of rod such as nanotubes, nanowires and the like, and biomaterials such as organic materials having amphiphilic characteristics, proteins, DNAs. The nanopattern structures may be used as an electron beam device in a field emitted display (FED), and applied to the manufacture of a composite material having high strength, a chemical sensor or biosensor, an energy reservoir, molecular electronic devices, highly integrated circuits and the like.

When these nanomaterials are coupled with electronic elements through chemical or physical bonding, it is possible to develop devices such as next-generation sensors, magnetic recording media, and transistors. Even further, the nanotechnology may lead development in related industries which have been developed based on the molecular concept of chemistry such as molecular biology, pharmaceutics, material engineering and electronic engineering.

The nanotechnology has emerged with increasing attentions since 1980, when a scanning tunneling microscope (STM) was invented by IBM research center in Zurich. The STM provided a new window through which molecular scale observation became possible, for example observation of single atom or single molecule during its handling. The STM is operated by: fixing a sharp tip formed of single atom precisely to the surface of a sample; flowing electrons through the space between the surface of a sample and the tip, in the form of tunnel, which results in weak electric current; measuring the strength of current over the sample surface; and thus reading the image of the surface in atomic level of resolution.

As a method for fixing nanomaterials to a substrate in a certain pattern, a semi-conductor process has been mainly used so far. For an example of such process, in order to coating a silicon (Si) wafer with gold or aluminum, the desired materials are mounted onto the substrate by using devices such as a sputtering machine, a chemical vapor deposition (CVD) device or a beam evaporator. In the above, for forming desired patterns, the deposition of nanomaterials comes after the masking of patterns by using a lithography machine, according to the photoresist patterns which have been pretreated on the surface. Then, through an etching process, undesired parts are removed and the desired patterns are only selectively remained, thereby achieving a substrate having nanomaterials fixed thereto. This method has advantages of achieving a very stable process and embodying the linewidth to the level of 0.1 [symbol] , however it also has problems that the applicable materials to this method are very limited, some processes should be conducted at high temperature, and it is difficult to work on a substrate having a size of more than 300 mm owing to the general standards of processing devices. Further, the resolution in an optical mode is limited, and this poses another big problem of geometrically increasing general cost for overcoming such limitation.

Recently, novel patterning methods are emerging one after another. For example, a method such as a microcontact printing method is carried out by applying nanomaterials to be attached to a substrate, together with ink, to the surface of a stamp having prepared patterns, and transferring the nanomaterials to the substrate to be printed by contacting the substrate with the stamp as it is. In the above, the substrate used in the transfer is generally coated with a material such as Au so that the ink comprising nanomaterials can be fixed well thereto. [Refer to: L. Yan; X. M. Zhao; G. M. Whitesides. “Patterning a preformed, reactive SAM using microcontact printing.” Journal of the American Chemical Society, 1998, 120 (24), 6179-6180].

As a similar method, nanoimprinting technique may be mentioned, which is conducted by firstly coating the surface of a substrate with the desired nanomaterials together with photoresist for making the patterns to be transferred, and forming patterns by pressing an uneven plate which has been previously manufactured for forming patterns onto the substrate, or transferring the patterns by UV light irradiation. This method also has problems that it is difficult to improve the preciseness over that of the conventional optical lithography since this method includes the manufacture of a master plate, and the materials are limited to only those suitable for processes under pressure or using UV. Further, the preciseness of this method becomes decreased as substrates having a wide range of size are applied thereto. [Refer to: S Zankovych, etc., Nanoimprint lithography: challenges and prospects, Nanotechnology 12, 2001,91-95].

Since the success in an experiment of embodying nanometer scale patterns by using a STM, patterning by using a scanning probe microscopy (SPM) has become to form a certain field of research in soft lithography technology. In 1998, K. Wilder, et. al conducted an experiment to form a pattern having the linewidth of about 30 nm by using an atomic force microscope (AFM). (Refer to: K. Wilder, D. Adderton, R. Bernstein, V. Elings, and C. F. Quate, “Noncontact nanolithography using the atomic force microscope,” Appl. Phys. Lett., vol. 73, no. 17, 2527-2529,1998). This experiment practiced a method of patterning the photoresist on a substrate by using an electron beam which is generated by applying voltage to the probe tip of an AFM. However, this method is still being investigated in laboratory scale, due to its low throughput.

Another method for patterning by using an AFM was developed, in which organic materials are applied to the end tip of the AFM as ink, and then patterns can be written with the tip of the AFM onto a substrate such as being made of Au, just like writing with a pen. This method is referred as a dip pen nanotechnology, and characterized in that the organic materials used as ink flow down from the end tip of an AFM to the surface of a substrate owing to diffusion and then couple with the molecules on the substrate to form patterns. (Refer to: R. Piner, S. Hong, C. A. Mirkin, Improved Imaging of Soft Materials with Modified AFM tips, Langmuir 15, 5457,1999).

Additionally, there is a patterning method currently developed by using CVD technique and the conventional semiconductor processes, in which nanomaterials such as carbon nanotubes (CNT) are grown on the surface of a substrate and then patterning is carried out. This method comprises firstly, coating of a substrate with catalysts so that CNTs can be grown on the substrate. In the above, the catalysts can be coated in a desired pattern by using a semiconductor process. The resulted substrate coated with the catalysts is subjected to a furnace having a flow of hydrocarbon gas to allow the reaction between the catalysts and the carbon gas thus to grow CNTs. Based on recently developed technologies, it is possible to grow the CNTs having a uniform diameter by controlling the size or amount of the catalyst. This method can be applied to a FED. However, this method still has problems that the work should be carried out under high temperature conditions, and the preciseness of patterning is determined by the degree of catalyst application. Still further, it has problems that the characteristics of the grown CNT is not easily adjusted to a metal, semiconductor or the like during the growth of the CNT as well as the physicochemical properties are not controllable, and as a result of that, it is very difficult to fabricate a structure which satisfies the desired mechanical, electrical, chemical property values at the same time.

‘Scanning probe microscope’ detects physical and chemical reactions in atomic scale, from the atoms on the surface of a sample by using a probe tip that is attached to the probe. This probe tip is served as a sensor for detecting physical or chemical reactions, by being attached to the most end tip of the probe. The structure of the probe may depend on the kinds of physical values to be detected. Generally, the finer structure the tip has, the unit of physical property value to be detected can get smaller. If the tip has a specific shape, it may be possible to perform a two-dimensional measurement, instead of one-dimensional measurement. Therefore, as the probe tip of such microscope, a carbon nanotube having a diameter of nearly 1 nm has recently come into use.

The scanning probe microscope includes: STM which measures the tunnel current; AFM which detects surface indentation by using Van der Waals atomic force; LFM (Lateral Force Microscope) which detects the surface differences by using friction force; MFM (Magnetic Force Microscope) which detects magnetic field characteristics by using a magnetic needle; EFM (Electric field force microscope) which measures the electric field by applying voltage between a sample and a probe; CFM (Chemical Force Microscope) which measures the surface distribution of chemical functional groups; SCM (Scanning Capacitance Microscope) which measures the capacitance between a sample and a needle; SThM (Scanning Thermal Microscope) which displays the thermal distribution of the surface as a differentiated image, EC-SPM (Electrochemistry Scanning Probe Microscope) which determines the electrochemical properties of a sample, and the like. These microscopes generally detect surface signals with very high resolution which reaches to the atomic level.

AFM is widely used in various fields of nanotechnology from basic researches to processing devices for the manufacture. The key technology which constitutes the most fundamental technical base of the AFM is on the probe tip. According to the shape and the size of the probe tip, the image resolution and reproducibility of the AFM is changed.

As one of the applications, a probe tip of an AFM can be mentioned. AFM is widely used in the field of evaluation and observation up to nanometer scale, and recently there are many on-going researches on the soft lithography using such AFM.

It is general for the AFM to have a sharp form like the shape of a pyramid on the end tip of a cantilever, however it is also possible to attach a carbon nanotube to the end tip of the pyramid for use. This is because the use of a tip having very high aspect ratio in atomic scale and excellent elasticity is advantageous for measurement.

With respect to this, it is known that a carbon nanotube tip has ideal characteristics for improving the performances in the measurement, operation and manufacture of an AFM, by having sharpness, high aspect ratio, high mechanical stiffness, high elasticity, controllable chemical components and the like. The nanotube tip has advantages that it has a long service life, is advantageous for measuring a deep structure having narrow width, and is possible to obtain high resolution as much as 1 nm or less.

Conventional techniques regarding nanotubes include a method for depositing carbon nanotube (CNT) suggested by Oshima, et. al in U.S. Pat. No. 5,482,601, and a catalytic method for the mass production of multi-wall nanotube (MWNT) by Mandeville in U.S. Pat. No. 5,500,200.

Recently, a method for directly growing MWNT or single-wall nanotube (SWNT) has been developed by using CVD suggested by Hafner, et. al. (U.S. patent application Ser. No. 09/133,948). This method comprises applying catalyst particles for the individual growth of probe tips for AFM and allowing the particles to grow in the presence of hydrocarbon gas at high temperature. By the method, the individuals or bundles of MWNT or SWNT can be attached to the end tip of an AFM.

There is another method developed by Dai, which is very effective, comprising coating the end tip of an AFM with liquid phase precursors, growing the precursors by CVD, and then carrying out electric discharge for adjusting the size, thereby obtaining the AFM tip having a carbon nanotube attached thereto. (U.S. Pat. No. 6,401,526). In the method, the liquid phase precursors can be prepared by mixing metal-containing salts, long-chain molecular compounds and solvents. For the more effective attachment of the precursors, it also suggests a method for coating many pyramid shaped end tips at once by using microcontact printing.

There is another known method, in recent years, which comprises applying precursors on a wafer mounted with a large amount of silicon pyramids for AFM, then removing the precursors other than the precursors on the pyramid by etching process so as to remain the precursors at the end tip of the pyramid, and growing carbon nanotubes thereon by CVD in the atmosphere of a carbon-containing gas. (Refer to: Wafer scale production of carbon nanotube scanning probe tips for atomic force microscopy, Applied Physics letters, Vol. 80, No. 12, Erhan Yenilmez etc., March 2002, pp 2225-2227).

Other than the above methods, a method of directly attaching carbon nanotubes to an AFM by using an adhesive has now been in practical use. Piezomax, Co. commercialized a CNT probe for AFM through a method comprising attaching the bundle of MWNT and sharpening the end tip by grinding.

As mentioned so far, there have been many researches on attaching CNTs having excellent aspect ratio and physical properties to the AFM probe for investigating mechanical, chemical, biological characteristics. However, it is still practically difficult to mass-produce such CNT probes and to measure the side of a deep structure having narrow width i.e. so-called a trench structure, by using the same.

For measuring the deep and steep step height, a method which comprises forming projected parts having various shapes at the end tip of AFM probe has been known. (Refer to: Two-dimensional atomic force microprobe trench metrology system, Journal of Vacuum Science and Technology B., D. Nyyssonen etc., Vol. 9(6), pp 3612-3616, 1991). Such projected part can easily detect information from the side part, therefore it has an advantage of achieving more precise measurement of the surface signals of a steep structure. However, the formation of the projected part by fabricating the end tip of a probe is technically difficult, which hinders its practical use.

Recently, the semiconductor width becomes smaller as much as 0.1 um or less, and for the precise measurement of such small width in the process, the use of an AFM is required. However, with a general probe or tip of an AFM, it may be hard to achieve the precise measurement as well as to obtain information on the side of a deep and narrow trench.

### DISCLOSURE OF INVENTION

### Technical Problem

Therefore, taking those above-mentioned problems of prior arts into consideration, the present invention is to provide a novel nanopattern structure and a manufacturing method thereof, which makes possible to easily manufacture a nanopattern structure having a size larger than a nanopattern structure manufactured by general semiconductor processes; to manufacture various nanomaterials without being limited by raw materials; to produce precise patterns in nanosize; and to mass produce nanopattern structures as compared to the conventional patterning methods with low production cost.

Still, the present invention is to provide a mass production of a probe, which is possible to precisely measure the shape of various microstructures as well as to detect various physical, chemical and biological signals.

In the researches for solving those above-mentioned problems, the present inventors found that, when nanomaterials are stably dispersed into a volatile solvent and applied to an LB trough, it is possible to obtain an LB film which is aligned in a certain orientation at the interface between water and air, and when such LB film is transferred and attached to a substrate or a holder, it is possible: to easily manufacture a nanopattern structure having a size larger than a nanopattern structure manufactured by general semiconductor processes without being limited by the kinds of nanomaterials; to produce precise patterns in nanosize; to mass produce nanopattern structures as compared to the conventional patterning methods with low production cost; to carry out precise measuring even in the case of a structure having very narrow step height width; to manufacture a SPM probe being capable of detecting various physical, chemical and biological signals, thereby completing the present invention.

### Technical Solution

Therefore, the present invention provides a method for attaching nanomaterials to a substrate or a holder, which comprises forming an LB film of nanomaterials by applying a dispersed solution of the nanomaterials over the water contained in an LB trough, and transferring and attaching the nanomaterials of the LB film to a substrate or a holder.

Further, the present invention provides a method for attaching nanomaterials characterized in that the dispersed solution of nanomaterials is dispersed in a way of preventing the individuals or bundles of nanomaterials from being aggregated or precipitated in a volatile organic solvent.

The method for attaching nanomaterials may be used in the manufacture of a nanopattern structure or of a signal probe for detecting surface or chemical signals as a mechanical and electric device.

The expression “Technical or electric device” used herein means to include scanning probe microscopes which image the atomic alignment, data saving devices which handle magnetic information, sensors which detect biological or chemical signals, devices for measuring force or stress by using mechanical bending, or SPM devices utilized for soft lithography, on which researches have been much proceeded recently.

The method for attaching nanomaterials according to the present invention uses a monolayer of nanomaterials for attaching the nanomaterials to a substrate or a holder. For the preparation of the nanomaterial monolayer in the present invention, a dispersed solution of nanomaterials is used. The dispersed solution of nanomaterials may be prepared by various methods, and preferably it is prepared by dispersing nanomaterials into a volatile organic solvent in stable way.

The nanomaterials which have characteristics of being stably dispersed into a volatile organic solvent, may form a monolayer having a certain orientation at the interface between water and air, and also form a domain structure in nanometer scale by controlling the interaction between materials. The nanomaterials of the LB film thus prepared are transferred to a solid substrate or a holder, and by inducing the interactions between the nanomaterials and the substrate, it is possible to manufacture a structure where the nanomaterials are firmly bonded to the substrate.

Herein, the expression that the nanomaterials are dispersed into a volatile organic solvent in stable way, means that the individuals or bundles of nanomaterials are dispersed without being aggregated or precipitated in the volatile solvent. Therefore, the nanomaterials useful in the present invention are preferred to have properties as such that the aggregation between the individuals or bundles of nanomaterials are not occurred and can be dispersed into a volatile solvent without being precipitated, or to be pretreated to have such properties as mentioned right above.

In the pretreatment of the nanomaterials, which makes the nanomaterials to be dispersed into a volatile solvent without being precipitated in the volatile solvent while preventing aggregation between the individuals or bundles of nanomaterials therein, various methods can be used. For example, when a functional groups having affinity to the volatile organic solvent are added to the part of the nanomaterials in the pretreatment, the nanomaterials become to have properties as such that the aggregation between the individuals or bundles of the nanomaterials is not occurred and stable dispersion thereof is achieved without being precipitated in the volatile solvent.

The state of stable dispersion of the nanomaterials in a volatile solvent according to the present invention is essentially required for the formation of a nanomaterial monolayer, and the orientation and the alignment of the nanomaterials.

The example of nanomaterials useful in the present invention includes nanomaterials having a shape of rod such as nanotubes, nanoneedles, nanowires and the like, nanomolecules in the form of particles such as gold (Au), aluminum (Al) and the like, which are often used, and biomaterials having organic materials having amphiphilic characteristics, proteins and DNA. The example of the nanotubes include carbon nanotubes in the shape of rod having a radius ranged from several nanometers to hundreds of nanometers, BCN type nanotubes, boron nanotubes, BN type nanotubes and the like; and the example of the nanoneedles include rod shaped nanoneedles without hollow core, made of metals such as Tungsten and Steel, and the like.

### BRIEF DESCRIPTION OF THE DRAWINGS

FIG. 1 illustrates the process of fabricating a nanotube monolayer by using a Langmuir-Blodgett(LB) method,

FIGS. 2a, 2b, 2c illustrate a method for attaching a Langmuir-Blodgett (LB) film of nanomaterials, which are aligned in a certain orientation at the interface between water and air, to a substrate,

FIG. 3 illustrates the process of attaching the nanotube LB film of the nanotubes, which are aligned in a certain orientation at the interface between water and air, to a probe for AFM,

FIG. 4 illustrates the structure of a signal probe made of the nanotube according to one of preferred embodiments of the present invention,

FIG. 5 is a scanning electron microscopic (SEM) image of the carbon nanotube vertically attached to a probe for AFM, by the LB method.

### MODE FOR THE INVENTION

In the formation of a monolayer of nanomaterials according to the present invention, Langmuir-Blodgett (LB) method is used. For example, as disclosed in the FIG. 1, amphiphilic nanotubes (1) which have been dispersed into a volatile solvent in a stable state are applied over water contained in an LB trough (2), and pushing a barrier (3), after evaporation of the solvent, to gradually reduce the area of the water surface and thus to obtain an LB film where the nanotubes are aligned in a certain orientation at the interface.

In order to obtain an LB film having a certain orientation in more effective way, it is preferred to set up suitable conditions for the film formation according to the types of nanomaterials, or to make the nanomaterials to have amphiphilic characteristics by imparting hydrophilic functional groups to one end of the nanomaterials and non-hydrophilic functional groups to the other end of the nanomaterials. Additionally, the nanomaterials can be made to be aligned in one direction on the LB film by using electric or magnetic field. In general nanomaterials, for the alignment thereof to one direction, when an electric field is applied thereto, electric charges are generated at the both ends of the nanomaterials, or if the nanomaterials have already had electric charges, they get aligned in the polar direction of the applied electric or magnetic field. In that time, if a weak electric field which is not as strong as to draw the nanomaterials, is applied, or the polarity is continuously changed by an alternating electric field, the nanomaterials can be aligned.

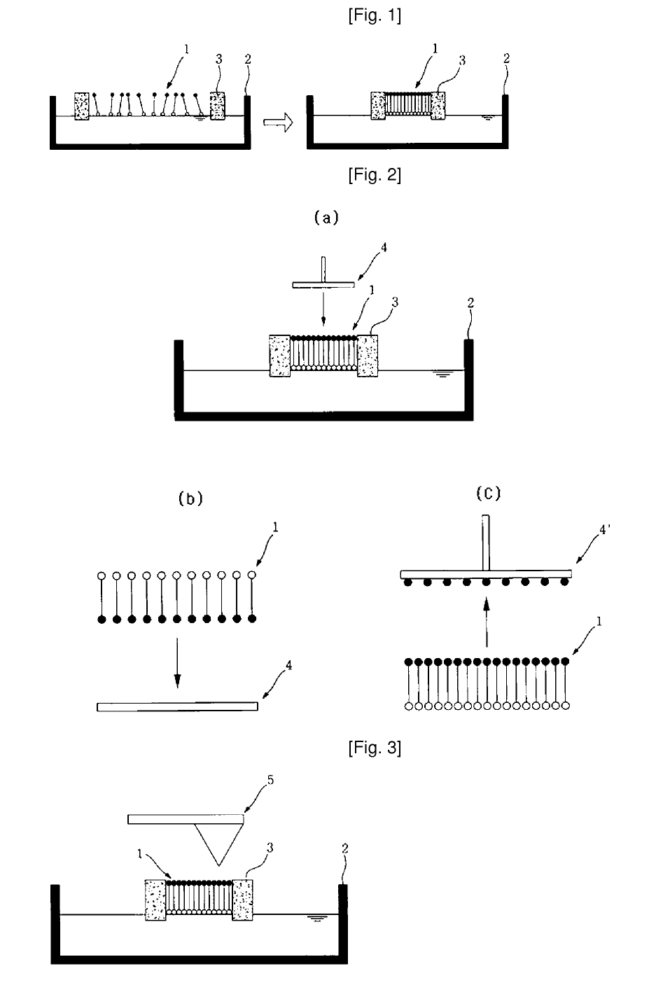

FIGS. 2a and 2b illustrates a method for attaching the nanotubes of an LB film to a substrate (4), specifically FIG. 2a illustrates a method for attaching nanotubes by moving the substrate (4) to the LB film, and FIG. 2b illustrates a method for attaching nanotubes by moving the LB film to the substrate (4). These methods make possible to conveniently manufacture a nanopattern structure where a domain structure of the nanotubes is attached to a substrate. FIG. 2c illustrates a method for attaching nanotubes by moving a substrate (4′) to the LB film, in which the substrate (4′) has been modified to form chemical bonds with the functional groups formed on one end of the nanotubes only in a certain pattern. This method allows manufacturing of a nanopattern structure in which nanotubes are attached to a substrate in a certain pattern in convenient way.

FIG. 3 illustrates a method for attaching the nanotubes of an LB film to a probe (5) such as a probe for AFM, which allows manufacturing of a functional nanotube signal probe in convenient way.

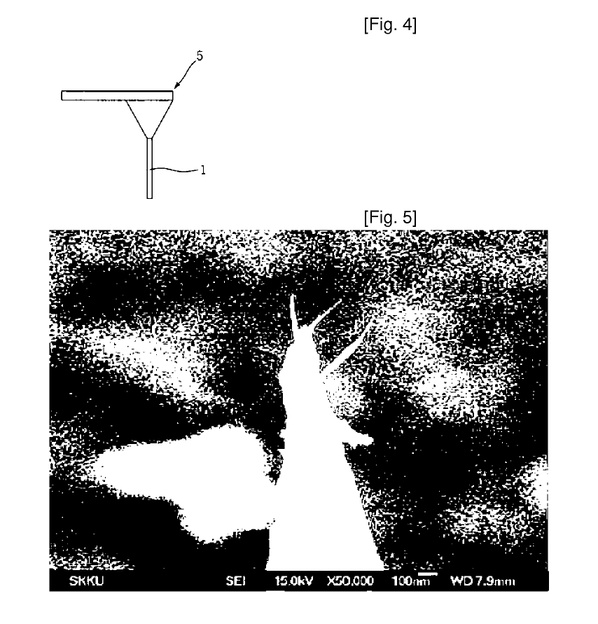

FIG. 4 shows a signal probe for, a type of SPM, AFM where a nanotube is attached in ideal form. The present invention is by no means limited to this, but it may be applied to various types of SPM or wide range of sensor probes for detecting physical, chemical and biological signals.

As being illustrated, when one end of a nanotube (1) is fixed to the tip of a probe (5), the other end is allowed to be stood out from the probe tip, it is possible to detect surface information of a sample, or other physical, chemical and biological signals from outside through the protruded end part. FIG. 5 is an electron microscopic image of a probe tip having a nanotube attached thereto according to the method of the present invention.

Probe tips which generally have a shape of pyramid, are manufactured through an etching process used in a semiconductor process, and cantilevers are mainly made of silicon or silicon nitride.

For making the attachment of the nanomaterials to a substrate or a holder rather stronger according the present invention, it is also possible to impart functional groups or a monolayer which can make chemical bonds with functional groups attached to the part of the nanomaterials, to a substrate or a holder. For example, when the end of a carbon nanotube is modified with SHx, it is possible to make a stronger bond by applying Au which easily forms a chemical bond with the SHx to a substrate or a holder since chemical bonding is formed at the time of attachment of the nanomaterials to the substrate or holder.

Additionally, if the LB film is transferred to a substrate which has been modified for the functional groups of the nanomaterials to be attached in a certain pattern, it is possible to obtain a nanopattern structure having desired patterns. For providing such patterns to a substrate, it is possible to use: a method in which a monolayer comprised of molecules having cavities, for example calix[n]arene, cyclodextrine and the like, is formed on a substrate, and then the functional groups of the nanomaterials of an LB film are bonded to the substrate through the cavities; a method in which a monolayer is formed on a substrate by using molecules having different sizes, one of two species of molecules is removed therefrom so as to form holes and then the functional groups of nanomaterials are bonded to the substrate through the holes; or a method in which patterns being capable of bonding with the functional groups of the nanomaterials are formed on a substrate by using methods such as templating, microcontact printing, nanoimprinting, dip pen technique, or semiconductor lithography.

The present invention has advantages that it is possible to produce an LB film under relatively low temperature condition such as room temperature, to pattern a wide area as much as 300 mm or more at once, and to manufacture a mass amount of nanostructures as compared to the conventional method under same conditions. Further, in the present invention, the species of raw materials constituting nanopatterns to be manufactured are hardly limited, unlike other conventional methods, therefore the present invention also has an advantage of utilizing various materials such as organic molecules, biochemical materials, metal nanoparticles and the like. Accordingly, owing to such characteristics, the present invention is applicable to manufacture of devices or patterns used in various fields including bio-electronics, molecular-electronics and the like.

### INDUSTRIAL APPLICABILITY

According to the present invention, it is possible to easily manufacture a nanopattern structure having a size larger than a nanopattern structure manufactured by general semiconductor processes; to manufacture various nanomaterials without being limited by the species of raw materials; to produce precise patterns in nanosize; to mass produce nanopattern structures as compared to the conventional patterning methods with low production cost; and to work at room temperature, thereby being able to utilize various substrates. Further, according to the method of the present invention, it is possible to manufacture signal probes including SPM, wherein the resulted probe has advantages: of being capable of detecting surface information which has been difficult to detect by using conventional probes; of very high aspect ratio and elasticity as compared to the conventional ones; of prolonging the service life significantly; and of being suitable for mass production since the detect probe can be manufactured by a series of chemical processes. The applications which can be mentioned include AFM, STM and other SPM, biosensors, chemical sensors and the like.

1. A method for attaching nanomaterials to a substrate or a holder, which comprises forming an LB film of nanomaterials by applying a dispersed solution of the nanomaterials over the water contained in an LB trough, and transferring and attaching the nanomaterials of the LB film, to a substrate or a holder.

2. The method for attaching nanomaterials to a substrate or a holder according to claim 1, characterized in that the dispersed solution of the nanomaterials is obtained by dispersing the nanomaterials into a volatile organic solvent in a way of preventing aggregation or precipitation of the individuals or bundles of the nanomaterials.

3. The method for attaching nanomaterials to a substrate or a holder according to claim 2, characterized by further comprising a step of providing functional groups having affinity to the volatile organic solvent, to the part of the nanomaterials before dispersing the nanomaterials into the volatile organic solvent.

4. The method for attaching nanomaterials to a substrate or a holder according to claim 3, characterized by providing hydrophilic groups to one end of the nanomaterials and non-hydrophilic groups to the other end of the nanomaterials.

5. The method for attaching nanomaterials to a substrate or a holder according to claim 1, characterized by further comprising a step of providing functional groups or a monolayer which can be chemically bonded with the functional groups formed on the part of the nanomaterials, to the substrate or holder.

6. The method for attaching nanomaterials to a substrate or a holder according to claim 1, characterized by further comprising a step of providing a certain pattern being capable of bonding with the functional groups of the nanomaterials to the substrate.

7. The method for attaching nanomaterials to a substrate or a holder according to claim 1, characterized in that the nanomaterials are aligned in one direction on the LB film by using electric or magnetic field.

8. The method for attaching nanomaterials to a substrate or a holder according to claim 1, characterized in that the nanomaterials are nanotubes, nanoneedles, nanowires, nanomolecules in the form of particles, organic materials having amphiphilic characteristics, biomaterials such as proteins or DNA.

9. The method for attaching nanomaterials to a substrate or a holder according to claim 1, characterized in that the holder is a signal probe holder having a protruded end, and the nanomaterials of the LB film are transferred and attached to the end of the signal probe by bringing the nanomaterials on the LB film and the signal probe into close contact.

10. The method for attaching nanomaterials to a substrate or a holder according to claim 9, characterized in that the probe is a probe for scanning probe microscope (SPM).

11. The method for attaching nanomaterials to a substrate or a holder according to claim 2, characterized by further comprising a step of providing functional groups or a monolayer which can be chemically bonded with the functional groups formed on the part of the nanomaterials, to the substrate or holder.

12. The method for attaching nanomaterials to a substrate or a holder according to claim 3, characterized by further comprising a step of providing functional groups or a monolayer which can be chemically bonded with the functional groups formed on the part of the nanomaterials, to the substrate or holder.

13. The method for attaching nanomaterials to a substrate or a holder according to claim 4, characterized by further comprising a step of providing functional groups or a monolayer which can be chemically bonded with the functional groups formed on the part of the nanomaterials, to the substrate or holder.
